(19) United States
(12) Patent Application Publication
(10) Pub. No.: US 2012/0310718 A1
(43) Pub. Date: Dec. 6, 2012

(54) SYSTEM AND METHOD FOR RANDOMLY PROVIDING FREE GOODS AND SERVICES

(76) Inventor: Justin Ozinga, Frankfort, IL (US)

(21) Appl. No.: 13/486,804

(22) Filed: Jun. 1, 2012

Related U.S. Application Data
(60) Provisional application No. 61/492,438, filed on Jun. 2, 2011.

(51) Int. Cl. G06Q 30/02

(52) U.S. Cl. 705/14.23; 705/14.1

(57) ABSTRACT

A system and method is disclosed for merchants or vendors to contract with a company to accept a particular credit card, software application or gift card. The card or software application is linked to a proprietary software system that incorporates payment terminals. Consumer use the credit card or a software application on a computer device to purchase goods or services and the proprietary software randomly selects a predetermined percentage of the transactions at that merchant to be free of charge. Neither the consumer nor the merchant know when making the purchase which transaction will be free of charge.

### PRIORITY STATEMENT

This application claims the benefit of U.S. Provisional Application No. 61/492,438, filed Jun. 2, 2011.

### FIELD OF THE INVENTION

The present invention relates generally to the field of credit card or gift card purchases, and more particularly the present invention relates to a credit program or credit card system and method for providing a percentage of purchases made using the credit program, credit card or a related software application to be free of charge or at a reduced cost. For example, if the system provides for ten percent of free or reduced purchases then, for every ten purchases made utilizing a credit card or software application of the present invention, one random purchase may be free of charge or at a reduced cost.

### BACKGROUND OF THE INVENTION

Historically, individuals used cash or some form of barter to purchase goods or services. Credit, which is an approval for delayed payment for purchased goods or services, was not easy to obtain. Usually, credit was only given if the retailer or person providing the credit had personal knowledge of the individual seeking the credit, and knowledge as to whether that individual would be able to pay off the debt at some time in the future. In most cases, the credit provided for the goods or services was paid back with interest. Even so, most merchants or service providers did not want to provide credit due to the chance of a default, i.e., that the loan would not be paid, and even if paid, there would be a delay in receiving the payment.

Of course, as long as there were ramifications to the borrower if the loan was not paid off, individuals could be provided credit with the chance of a default diminishing based on those ramifications. Accordingly, with diminishing defaults, those providing credit, even if they were not the actual merchant or service provider, could then obtain a return on their investment that made providing credit worthwhile. As such, creditors could provide credit, make a payment to the merchant or service provider that sold the goods or provided the services, and obtain interest from the individual obtaining credit.

These credit providers enabled individuals to make purchases based on future earnings which would be a benefit to all of the parties involved. Further, as the credit industry became more sophisticated, the credit lender, understanding the benefits to the retailer, could also demand a fee from the merchant to allow an individual to use credit to make a purchase. For that fee, the retailer would receive the payment whether or not the individual paid back the credit provider.

To make these purchases on credit easier, the credit providers supplied credit cards that listed the name of the individual receiving credit. The individual could show the credit card to the merchant and receive immediate credit for the purchase. Credit cards evolved to include information that could be scanned in using a magnetic strip for even easier access to information. Currently, credit can be obtained using a credit card, a fob, or even one's cellular telephone to transmit the borrower's information and to allow for a check of the available credit for the borrower. Information is transmitted from the card or device to the merchant's receiving device and the credit relationship is checked and established.

As more and more individuals were able to obtain and use credit or credit cards for purchases, the credit industry grew to a point that consumers now have a choice of credit cards and credit card companies for which they can establish a credit relationship. Further, as the credit business became more profitable, merchants and service providers themselves began providing credit and credit cards to their customers in direct competition with the credit card companies.

Based on the large number of companies and merchants providing credit cards, there is a fierce competition to get consumers to apply for and use a particular credit card. Over time, credit card companies and then merchants began to provide incentives to consumers that used their credit card. For example, credit card companies began to provide consumers with a “cash back bonus” if the consumers used their credit cards. Depending on how much the card is used and the amount of the purchases, the user may receive 1 or 2 percent back from those purchases.

For instance, if a consumer uses a particular credit card to purchase items for an average of $2000 per month, after one year spending $24,000, the consumer may receive a check from the credit card company for $480 (2% of $24,000). As such, a consumer is more likely to use a credit card from a company that pays back a percentage of the cost of purchases, or provides some other benefit, as opposed to a credit card that does not provide any benefits at all.

Further, a particular credit card may be tied to a merchant that provides a benefit if the consumer uses that credit card. For example, many of the airlines have their own credit cards or are tied to a credit card company that provides their customers with “points” for using their credit cards. The points may be tied to each dollar spent using the card, and the points may also multiply if the card is used for airline travel on that particular airline, or if it is used for a purchase from one of the airline's partners. These points can accumulated and later be used for travel on that airline or for goods or services from one of that airline's partners. Again, there is a benefit to using these credit cards over a credit card that does not provide any benefit for its use.

These latter types of credit cards are sometimes referred to as loyalty cards because the consumers that use the credit cards are more likely to patronize the merchant or company that is associated with that card to build up more points. For example, a United Airlines customer is more likely to travel on United Airlines (and possibly used the United Airlines credit card) than to travel on American Airlines if the consumer is obtaining points, even if a United flight to the same location as the American flight costs more.

Accordingly, based on the competitive aspect of the industry, consumers receive numerous offers to apply for credit cards from one or more companies. These companies must find a way to distinguish themselves and their credit card offering from the offering of others.

Traditionally, except for the credit received, credit card systems and methods failed to provide the necessary incentive for consumers to apply for and use a particular credit card. Based on the addition of loyalty programs and various reward programs, marketing and advertising schemes to entice new enrollees have become less effective. On the other hand, a simple reward program that is easy to understand and that is easy to implement can effectively market itself. Therefore, it is desirable to have a credit card system and method that is easy to implement, easy to understand and that can effectively market itself. The present invention solves this and other disadvantages of the prior art.

### SUMMARY OF THE INVENTION

It is an object of the present disclosed system and method to provide consumers with an opportunity to receive products and/or services at no charge or at a reduced cost, while providing a merchant or service provider with an opportunity to increase the traffic to and sales of its goods or services.

It is another object of the present invention for merchants or service providers to contract with a credit card company to accept a particular credit card, a software application or a gift card, or to set up a buying club for members of the club. The credit card or buying club is linked to a proprietary software system that incorporates one or more payment terminals. Consumers use the credit card, gift card or buying club to make purchases and the proprietary software randomly selects a predetermined percentage of the transactions at each participating merchant or service provider to be free of charge or to be provided at a reduced cost. The consumer does not know when making the purchase which transaction will be free of charge. By providing a certain number of products and services at no charge, if the purchase is selected, there is no perceived reduction in value of the goods or services, since the consumer originally paid full price for the goods or services.

It is yet another object of the present invention for particular merchants or service providers to contract with a company to allow for the purchase of goods and services by operating a software application, for example an application on a cellular telephone, computer tablet or a personal computer. The software application can be linked to credit card and a proprietary software system. Consumers that have linked a credit card to the software application, can make a purchase at the particular merchant and the proprietary software system randomly selects a predetermined percentage of the transactions at each participating merchant or service provider to be free of charge or to be provided at a reduced cost. The consumer does not know when making the purchase which transaction will be free of charge.

Merchants utilize the proprietary software system and payment terminals to determine which transactions are to be free of charge. Further, the determination or selection process can be done at the merchant, done by the credit card company, or outsourced to a third party that can make such a determination. These free of charge or reduced cost determinations can occur on a daily, weekly or monthly basis.

Consumers will desire to obtain and use the credit card or gift card for the opportunity to receive products or services at no charge or at a reduced charge each time they shop at participating merchants using that particular credit card. Merchants and service providers will desire to participate for the increase in consumer traffic (and thus purchases) they will experience as a result of offering a no charge transaction to a percentage of the consumers who purchase their goods or services using the particular credit card.

It is a further objective of the present invention to provide a system and methods that include a proprietary software system linked to merchant or vendor payment terminals that selects a percentage of all consumer transactions based on a predetermined percentage. For example, 1 in 10 or 10% of all purchases at each merchant or service provider may be at no charge (or at a reduced charge). The chance of obtaining goods or services free of charge or at a reduced cost would increase sales and generate revenue to merchants or service providers for transactions processed with the credit card or through the credit card system.

The foregoing and other aspects, features, details, utilities, and advantages of the present teachings will be apparent from reading the following description and claims, and from reviewing the accompanying drawings.

### BRIEF DESCRIPTION OF THE DRAWINGS

Aspects, features, details, utilities, and advantages of the present invention will be apparent from reading the following description and from reviewing the accompanying drawings and photographs, where:

FIG. 1 depicts a system in which consumers apply for and obtain a credit card or become a member of a club in which purchases are made and a percentage of those purchases are determined to be free of charge.

FIG. 2 shows a flowchart depicting an exemplary embodiment of a method in which consumers apply for and obtain a credit card or become a member of a club in which purchases are made and a percentage of those purchases are later determined to be free of charge.

### DETAILED DESCRIPTION OF EMBODIMENTS OF THE INVENTION

The present disclosure contemplates a buying club, gift card or credit card system and method for providing consumers with an opportunity to receive products and/or services at no charge or at a reduced charge while providing a merchant or service provider with an opportunity to increase sales of goods or services. One exemplary embodiment of the present disclosure provides for consumers that obtain a credit card linked to the present invention are rewarded by receiving a percentage of their purchases at no charge or at a reduced charge. Another exemplary embodiment of the aspect of the present disclosure provides for consumers to download a software application onto a handheld device, such as a cellular telephone or a computer tablet, and then link the software application with an existing credit card. When the consumer uses the software application to purchase an item, the consumer may be rewarded by receiving a percentage of their purchases at no charge or at a reduced charge. Payment using a handheld device can be accomplished in many ways; such as scanning a bar code or a QR code, utilizing a chip embedded in the handheld device, using a communications standard, such as Bluetooth, texting a payment request to a particular number, and numerous other methods. Yet another exemplary embodiment of the aspect of the present disclosure provides for consumers that become members of a buying club linked to the present invention are rewarded by receiving a percentage of their purchases at no charge or at a reduced charge. These and other non-limiting embodiments and aspects of the present invention will be described below.

As described herein, the present invention is a system and method of providing consumers with an opportunity to receive products and/or services at no charge or at a reduced charge, while providing merchants or service providers with an opportunity to increase their sales of goods or services. Merchants or vendors contract with a credit card company to accept a particular credit card, software application, or gift card becoming participating vendors. The credit card, software application or gift card is linked to a proprietary software system that may incorporate one or more payment terminals residing with the participating vendors, or in which the participating vendors have access for completing transactions. Consumers join the club, download the software application to their handheld device (and link an existing credit card), or apply for the credit card and, to the extent that the consumer has the requisite credentials, the consumer will be accepted into the buying club or receive a credit card issued by the merchant or by a credit card company, or purchase a gift card with a certain value preloaded on the card.

For ease of reference, the example above for obtaining a credit card will be referred to herein. This credit card example and reference is in no way meant to limit the scope of the disclosed invention.

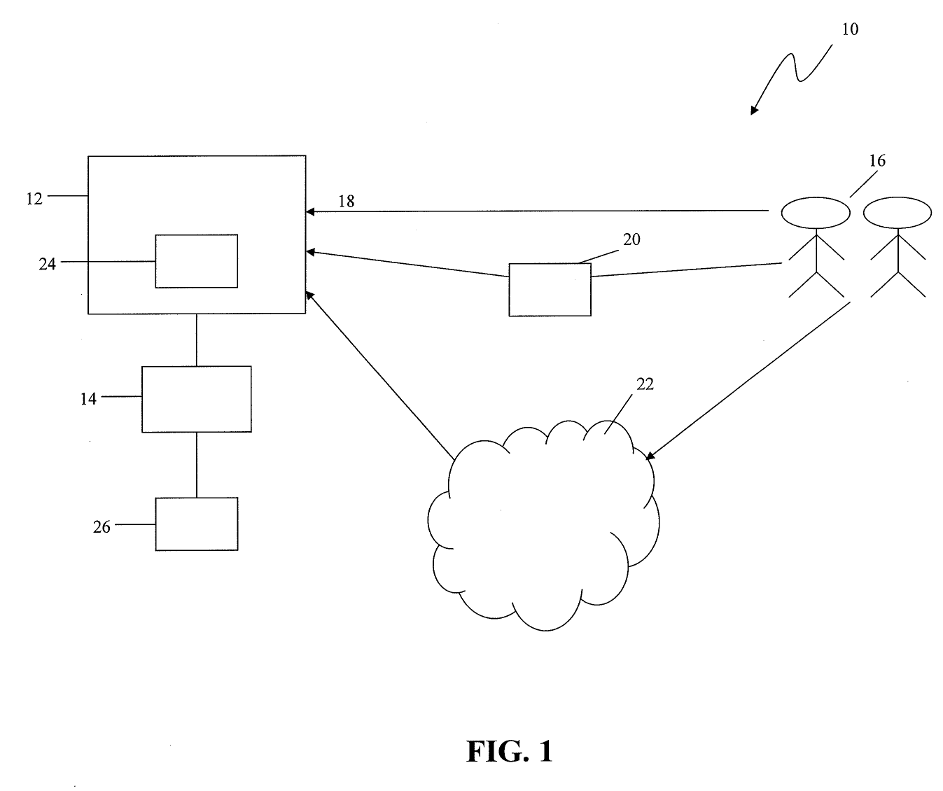

As described herein, once the consumer receives the credit card, purchases can be made using that card in person, through the Internet or over the telephone. FIG. 1 shows a block diagram of the credit card transaction system 10 in accordance with the present invention. The credit card system includes the merchant 12, which may be a typical brick-an-mortar establishment, an Internet website or any merchant or service provider that is permitted to establish a payment terminal that accepts credit card transactions.

In the preferred embodiment, the merchant 12 establishes a payment terminal 14 in accordance with the present invention that allows for the merchant 12 to accept credit card purchases from one or more consumers 16. Consumers 16 purchase goods or services in person 18, over a telephone 20 or through the Internet 22. If the transaction takes place over the Internet 22, the merchant 12 may use a computer 24 at the merchant's 12 location, however, the transaction may also occur outside of the merchant's 12 physical location.

Proprietary software 26 for use in the present invention can be located in the payment terminal 14 for accomplishing the purchase transaction, however, the software can also be located in the merchant's computer 24 or at a remote site (not shown). Further, the proprietary software 26 may be owned by the merchant 12 or may be owned by the credit card company, or by a third party altogether and leased to the merchant 12 for the particular use. Also, the proprietary software 26 may be owned by another party that provides outsourced or other services to the merchant 12.

As described herein, the proprietary software 26 selects a particular number of transactions made using the credit card (or a percentage of transactions) to be provided to the consumer 16 free of charge or at a reduced charge. These free of charge or reduced charge purchases are randomly determined and the number of purchases are based on a predetermined percentage or number based on the total number of purchases per merchant or service provider. For example, the predetermined number may be ten percent and the proprietary software 26 may select every one out of every ten purchases per merchant for which a consumer uses the credit card, to be free of charge. The predetermined number may be five percent and if the consumer using the card makes 100 purchases in a particular month, five of those purchases may be determined to be free of charge. Regardless of the predetermined percentage, the consumer 16 and the merchant do not know which transaction will be free of charge.

Participating vendors 12 must agree that they will provide the consumers using the credit card, the software application or the club member a randomly selected number (or percentage) of product or services at no charge.

In an alternative embodiment of the present invention, the consumer can download or upload a software application onto a handheld device, such as a cellular telephone, computer tablet or can install a software application onto a personal computer. The consumer can then link an existing credit card (or a credit card provided in accordance with the disclosure herein), to the software application. The software application can be further linked (when necessary) to a proprietary software system that can incorporate the functionality of the present invention. Between the software application and the proprietary software system, the functionality described herein can be accomplished. Consumers that have linked a credit card to the software application can make a purchase at a merchant that has agreed to the terms and agreed to accept purchases and allow for reduced payments or purchases free of charge.

Then, once a purchase is made by the consumer using the handheld device or personal computer, the software application and proprietary software system randomly selects a predetermined percentage of the transactions at each participating merchant or service provider to be free of charge or to be provided at a reduced cost. As described herein, the consumer can make a payment using a the handheld device or personal computer in many ways; such as entering product code or information via a touch screen or keyboard, selecting a product on a computer display, scanning a bar code or a QR code with a scanner or camera, utilizing a chip embedded in a handheld device, using one or more communications' standards or alliances, such as Bluetooth, ZigBee, Wi-Fi, etc. or texting a payment request to a particular number, among others. The consumer does not know when making the purchase which transaction will be free of charge.

As a non-limiting example, once a consumer has agreed to terms, downloaded the software application on his cell phone and successfully linked the software application to a credit card, he eats at a restaurant that has agreed to provide one in each of the ten patrons using the functionality of the present invention, a free meal. When the waiter brings the final bill, the consumer can pay for the bill by using the software application on his cell phone to enter the amount of the bill. The cell phone is linked to the proprietary software system (and the credit card) so the software system can decide if that particular purchase is free of charge. The consumer can be alerted when such a free transaction takes place.

To the extent necessary, a maximum dollar amount for the no charge transaction can be incorporated and disclosed in advance to the credit card or gift card holders or club members. A minimum dollar amount for the no charge transaction could also be required. A consumer 16 that makes a purchase using the credit card that is in excess of the maximum amount would have only the maximum amount deducted from their purchase price. For example, if the maximum amount is $100 and the consumer 16 uses the credit card for a $200 transaction, and that transaction is determined to be free of charge, the consumer 16 will only receive $100 off of the amount of the transaction. Further, credit card users and club members pay full price for those transactions that are not selected as free of charge. There may also be a penalty to the extent a credit card holder returns an item previously purchased but not determined to be free of charge. For example, merchants may be allowed to charge the consumer a re-stocking fee or cancellation charge.

The proprietary software 26, using information obtained from the payment terminals 14, pools all of the vendor's transactions and randomly selects the transactions that will be free of charge. Further, the selection process (which may be outsourced) can make the determination on an immediate, daily, weekly or monthly basis.

For example, if a merchant 12 had 30 club members or credit card holders make purchases in a day and the percentage of free transactions was 10%, 3 of those transactions randomly selected would be free of charge or at a reduced charge. For example, 27 consecutive purchases could be at the vendor's price and the final 3 purchases would be at no charge (or reduced by the maximum amount). Neither the vendor 12 nor the consumer 16 would have input or knowledge as to which transactions are free of charge.

Consumers 16 will want to obtain and use the credit or gift card or become club members for the opportunity to receive a product or service at no charge or a reduced charge each time they shop at that particular vendor 12. Vendors 12 will desire to participate in the system 10 for the increase in consumer traffic they will experience as a result of offering a no charge transaction to a percentage of the club members 16 who purchase their goods or services.

Also, to the extent a third party provides the credit card services, that third party can further charge the merchants 12 for providing credit to the consumers for the purchases as well as receive interest based on the revolving credit that the consumer 16 does not pay off. These charges are well known in the industry and similar to the fees charged by the major credit card companies, such as Visa, Mastercard, American Express and Discover. The buying club could generate revenue from processing fees charged to merchants each time a transaction is processed through the buying club, and from annual card fees charged to the consumer.

In an alternative embodiment, a merchant of a retail establishment can incorporate the present invention such that a percentage of items are randomly provided free of charge, whether or not the customer uses a credit card. For example, a restaurant that sells hamburgers and hot dogs incorporates the present invention such that ten percent of all hamburgers sold will be free of charge (or at a reduced cost to the consumer). In this exemplary embodiment, the system would keep track of the number of hamburgers sold at the restaurant and randomly choose one out of every ten hamburgers (or a similar ratio) to be provided free of charge. The customer may have to pay for all of the other items purchased along with the “free” hamburger, or the system can be set up so that one out of ten customers receive their entire order free of charge. Alternatively and as described herein, for that selected customer, his or her entire order can be free of charge.

Further, the exemplary embodiment described above can be incorporated by using a loyalty card program for the particular merchant. In this way, only customers having the merchant's loyalty card (or a similar arrangement) can be counted towards and receive the item free of charge. If the customer provides the loyalty card at the beginning of or during the transaction. If the percentage is set at ten percent or one in ten (in this example), then one random customer displaying his or her loyalty card will receive the item free of charge. In this example, those purchasing a hamburger and not using a loyalty card would neither count towards the total number of users, nor be able to receive the item(s) free of charge.

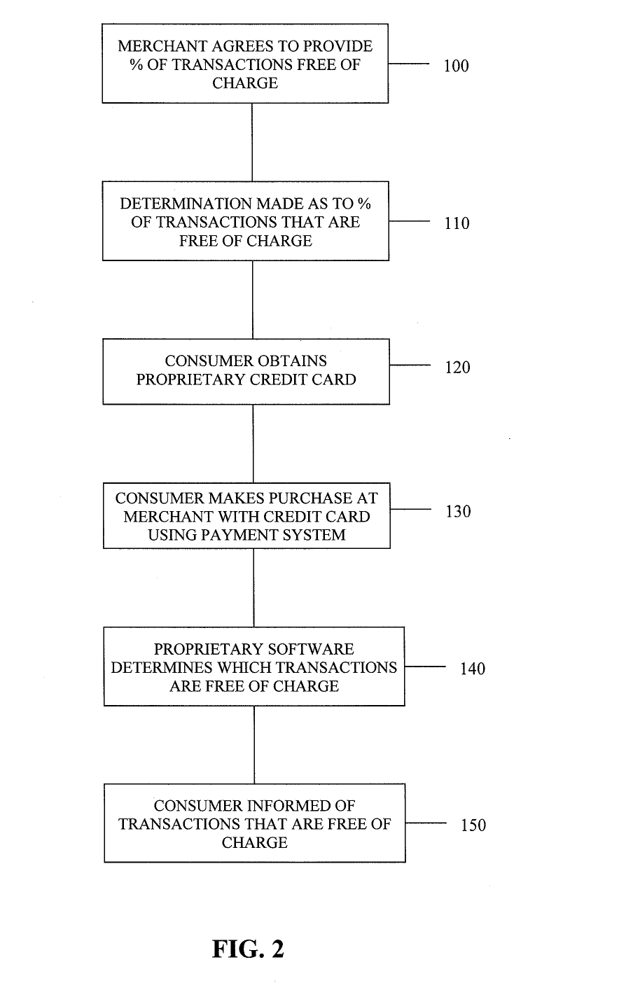

FIG. 2 shows one exemplary method of operating the disclosed credit card system in an embodiment wherein certain transactions are free of charge. In the first step 100, the merchant 12 agrees to provide a percentage of purchases in which the particular credit card is used, free of charge. In the next step 110, a random determination is made as to the percentage of transactions that are to be free of charge. As described herein, the percentage can be any amount, such as ten or five, but the present disclosure is not limited to these amounts. Further, the system can incorporate certain milestones, for example, five percent of the first ten purchases each month can be free of charge and then 10% of the remaining purchases can be free of charge. Also, the system can be set up so that a number or percentage of purchase transactions are free of charged or reduced for a particular time period. For example, in the month of May, ten percent of all purchases will be free of charge, or on April 6^{th}, twenty-five transactions will be free of charge.

In step 120, the consumer 16 applies for and obtains a credit card for the system 10. The consumer 16 then uses that credit card at the particular merchant 12 to purchase goods or services 130. The proprietary software in step 140 randomly determines which of the transactions purchased with the credit card at the particular vendor 12 are going to be free of charge.

Finally, step 150 allows for the consumer 16 to be notified as to which of the purchases made at that vendor 12 are free of charge. This notification may be immediate at the checkout register with a statement on the receipt that the transaction was free of charge. The notification may also be in the form of a letter or email at a later date or time notifying the credit card holder that the particular transaction was free of charge.

Although the present invention has been described in considerable detail with reference to certain preferred versions thereof, other variations are possible. Therefore, the spirit and scope of the present invention should not be limited to the description of the embodiments contained herein.

What is claimed is:

1. A method for providing a credit card linked to a proprietary software system that incorporates at least one payment terminal, wherein said proprietary software system randomly selects a predetermined number of purchase transactions to be made at a discounted rate, the method comprising:
a) obtaining an agreement from a merchant to provide a number of purchase transactions at a discounted rate;
b) receiving multiple purchase transactions from consumers using said credit card and the at least one payment terminal at said merchant linked to the payment system;
c) determining which purchase transaction made using the credit card linked to said proprietary software system is to be made at said discounted rate, said determining of which purchase transaction is to be random; and
d) informing one of said consumer that one of said purchase transactions is discounted.

2. The method for randomly selecting a predetermined number of transactions to be made at a discounted rate in claim 1, wherein said predetermined number of transactions to be discounted is a percentage of transactions.

3. The method for randomly selecting a predetermined number of transactions to be made at a discounted rate in claim 2, wherein said percentage of transactions is ten percent.

4. The method for randomly selecting a predetermined number of transactions to be made at a discounted rate in claim 1, wherein said predetermined number of transactions to be discounted is based on the number of transactions over a set time period.

5. The method for randomly selecting a predetermined number of transactions to be made at a discounted rate in claim 4, wherein said set time period is one day.

6. The method for randomly selecting a predetermined number of transactions to be made at a discounted rate in claim 4, wherein said set time period is one month.

7. The method for randomly selecting a predetermined number of transactions to be made at a discounted rate in claim 1, wherein said discounted rate is 100%.

8. A method for randomly selecting a predetermined number of purchase transactions to be made a discounted rate, wherein said purchase transactions are completed using a computer device linked to a credit card and a proprietary software system, the method comprising:
a) obtaining an agreement from a merchant to provide a number of purchase transactions at a discounted rate;
b) receiving multiple purchase transactions from consumers using handheld devices containing said software application, said software application linked to said credit card and said proprietary software system;
c) determining which purchase transaction made using said handheld devices and said software application is to be made at said discounted rate, said determining of which purchase transaction is to be random; and
d) informing one of said consumers that one of said purchase transactions is discounted.

9. The method for randomly selecting a predetermined number of transactions to be made at a discounted rate in claim 8, wherein said predetermined number of transactions to be discounted is a percentage of transactions.

10. The method for randomly selecting a predetermined number of transactions to be made at a discounted rate in claim 9, wherein said percentage of transactions is ten percent.

11. The method for randomly selecting a predetermined number of transactions to be made at a discounted rate in claim 8, wherein said predetermined number of transactions to be discounted is based on the number of transactions over a set time period.

12. The method for randomly selecting a predetermined number of transactions to be made at a discounted rate in claim 11, wherein said set time period is one day.

13. The method for randomly selecting a predetermined number of transactions to be made at a discounted rate in claim 11, wherein said set time period is one month.

14. The method for randomly selecting a predetermined number of transactions to be made at a discounted rate in claim 8, wherein said discounted rate is 100%.

15. The method for randomly selecting a predetermined number of transactions to be made at a discounted rate in claim 8, wherein said computer device is a cellular telephone.

16. The method for randomly selecting a predetermined number of transactions to be made at a discounted rate in claim 8, wherein said computer device is a tablet computer.

17. The method for randomly selecting a predetermined number of transactions to be made at a discounted rate in claim 8, wherein said computer device is a personal computer.
